(19) United States
(12) Patent Application Publication
(10) Pub. No.: US 2005/0248066 A1
(43) Pub. Date: Nov. 10, 2005

(54) Outer surfaces of sun visors

(76) Inventor: Miguel Angel Sabrido Esteban, Barcelona (ES)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/276,359

(22) PCT Filed: May 22, 2001
(86) PCT No.: PCT/EP01/05898

§ 371 Date: Jul. 7, 2003

(30) Foreign Application Priority Data
May 22, 2000 (DE) 10025290.7

(51) Int. Cl. B29C 43/22

(52) U.S. Cl. 264/509

(57) ABSTRACT

The invention relates to a method for producing blow-moulded sun visors comprising outer surfaces with a preferred embodiment. The outer surface of the sun visor varies in colour, surface structure and roughness. An economically-produced sun visor can thus be obtained to match the interior fittings of any motor vehicle. The structure and roughness of the outer surface of the sun visor are complementary to the inner surfaces (4) of the blow mould (1, 1′). The colour of the outer surfaces of the sun visor is also adjusted according to the coloration of the polypropylene used (2). Said coloration is obtained from organic and inorganic pigments. The invention also relates to a zip-up material cover for sun visors, which can easily be taken off and changed as required. The zip is almost completely covered by the hem and therefore cannot be seen by the passengers in the vehicle.

### 1. TECHNICAL FIELD

The invention relates to sun visors of motor vehicles for shielding the head regions of the passengers against incident light. Such sun visors have different shapes, surface structures and functionalities.

### 2. PRIOR ART

Essentially, sun visors are manufactured since motor vehicles have been produced. They are a main part of the interior fittings of a motor vehicle and can vary in design, shape, used materials and structure depending on the quality of the interior fittings. Additionally, the sun visors can be equipped with additional technical devices for example mirrors or interior lights.

In the prior art different methods for the manufacture of sun visors are known. First technical constructions of sun visors consist of for instance a wire frame shaped like a sun visor which is filled by a stabilizing element, as for example paper board. Then, layers of foam material are glued on the large-surface sides of the stabilizing elements which cover the wire frame. The sandwich structure built in that way is subsequently covered by for example a plastic material or a cloth cover to provide a sun visor with attractive optical design.

Besides the conformation and the stabilizing of the sun visor the wire frame serves for containing links to attach the sun visor to appropriate places in the vehicle. According to a further embodiment of the prior art, plastic materials are foamed around the wire frame inside a form thereby forming a sun visor body. It is for example covered by plastic materials or cloth as described above.

According to a further, as such known method of manufacturing, sun visors are produced by blow molding, wherein a soft flexible tube made of plastic material is expanded by compressed air inside a blow mold. In this context the blow mold determines the later shape of the sun visor body. Such plastic sun visor bodies are manufacturable with low process efforts however, they are not attractive in surface structure and appearance. If required, the sun visor bodies are covered by for example plastic covers or cloth and in that way adapted to the interior fittings of the motor vehicle. In this process it is necessary that the main procedure steps are manually performed as for example covering the sun visor body by a cloth cover.

The production of optically attractive sun visors is technically complecated as well as time and cost consuming because of the huge number of procedure steps for manufacturing the sun visor body which are partially manually performed. An adaptation in colour of the sun visor to the interior design of the motor vehicle is only possible by choosing the appropriate cloth or plastic cover.

It is therefore the problem to integrate the colour and surface designing of sun visors into the manufacturing process. This applies in particular to blow molding. Sun visors with the same appearance can be produced more cost effective and in shorter time when substantially manually made design steps as for example covering processes are replaced by equivalent manufacturing steps in the blow molding process.

According to the prior art, ultrasonic sealing is used for covering sun visor bodies with plastic material. The covering plastic material can vary in colour and surface structure and so appropriately determine the appearance of the sun visor. With the especially expensive covering with cloth, the appearance of the sun visor body and its haptics are adapted to particularly luxurious standards. Thereto a stocking-like cloth cover is mounted on the sun visor body. For fastening the cloth cover the sun visor body comprises a special clamping arrangement so that the still open end of the stocking-like cloth cover is closed thereby and the sun visor body is completely encompassed by the cloth cover.

The clamping mechanism for closing the cloth cover produced in the blow molding procedure is very expensive in its manufacturing and cannot be opened and closed several times for example to change the cloth cover. On the other hand, the cloth cover is closed in such a way in cooperation with the clamping mechanism that only one seam is visible.

There are two further problems. The complicated production of a clamping mechanism has to be integrated in the manufacturing process of the sun visor body. Additionally, the cloth cover is not changeable so that especially in the case of soiling or wear only a completely new sun visor can be installed in order to repair the damages.

### 3. SUMMARY OF THE INVENTION

The solution to the problems of the prior art results from the present invention according to claim 1 and 4.

The present invention according to claim 1 comprises a method for manufacturing a blow molded sun visor from plastic material in particular polypropylene with different outer surfaces of the sun visors wherein the polypropylene of the blow molded sun visor is nontransparently colored and the surface structure and roughness of the outer surfaces of the sun visors is complementary shaped to the surface structure of the inner surfaces of the blow mold halves during blow molding.

By using colored plastics and structured inner surfaces of the blow mold halves in the blow molding process according to the present invention the procedure steps required for manufacturing are reduced because the covering by the above mentioned plastic layers or cloths are no longer necessary. Thus, sun visor bodies are produced with low expenses in the manufacturing process and cost-efficiently.

The second preferred embodiment of the present invention according to the claims 4 to 6 relates to a cloth cover with a zipper for sun visor bodies. The cloth cover with zipper is simply mountable on the sun visor body and changeable wherein the zipper is sewn in that way in the cloth cover that it is partly or completely covered by the ends of the cloth cover to which it is attached.

Therefore, the manufacturing of a clamping mechanism for the cloth cover in the sun visor body is no longer necessary and the cloth cover is changeable by anyone as desired.

Corresponding to a further embodiment, the zipper is according to claim 7 and 8 invisibly arranged at the narrow front side of the sun visor body, preferably at the side opposite to the passengers and in the direct vicinity of the bearing axis of the sun visor in order to thereby improve the appearance of the sun visor.

### 4. SHORT DESCRIPTION OF THE DRAWING

The preferred embodiments of the invention result from the subclaims and are illustrated with support of the following specification and the drawing. It shows:

FIG. 1 (A) a schematic presentation of procedure step 1 of a method for manufacturing blow molded sun visor bodies from polypropylene according to a first preferred embodiment: Feeding the blow mold halves with a plastic flexible tube;

FIG. 1 (B) a schematic presentation of procedure step 2 of a method for manufacturing blow molded sun visor bodies from polypropylene according to a first preferred embodiment: Inflated flexible tube from polypropylene in the closed blow mold;

FIG. 2 (A) cut-out presentation of a sun visor with cloth cover according to the second preferred embodiment wherein the zipper closing the cloth cover is attached to the opposed ends of the cloth cover;

FIG. 2 (B) cut-out presentation of a sun visor with cloth cover according to a third preferred embodiment wherein the zipper closing the cloth cover is attached to 180°-folded, opposed ends of the cloth cover; and

FIG. 2 (C) presentation of a sun visor with cloth cover according to a second or third preferred embodiment wherein the zipper closing the cloth cover is arranged at one of the narrow front sides of the sun visor.

### 5. DETAILED DESCRIPTION OF THE INVENTION

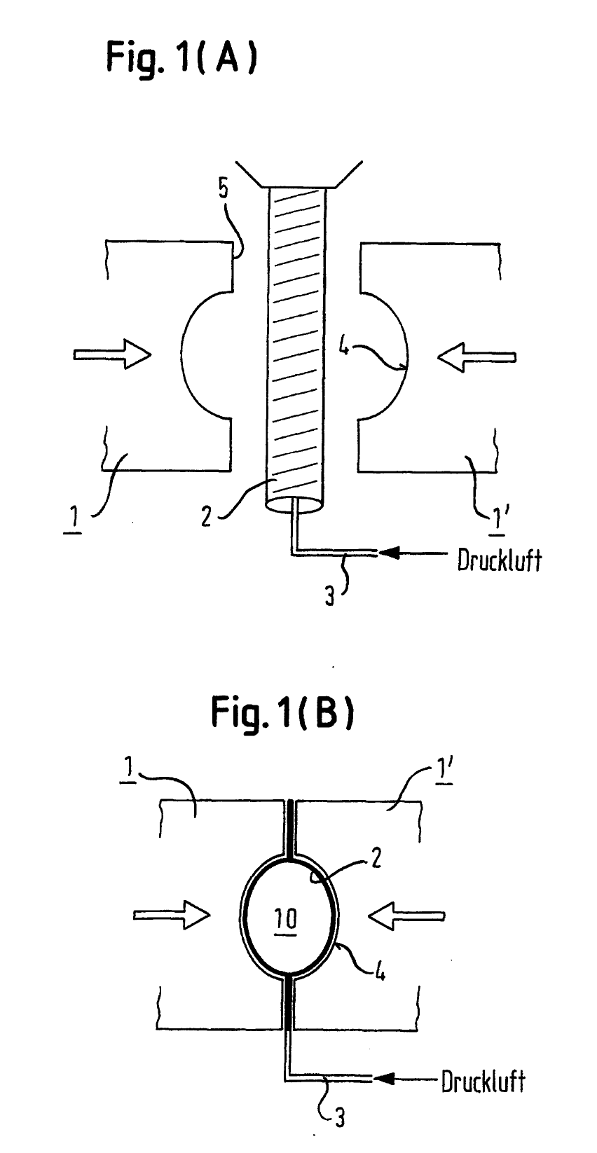

The manufacturing of the sun visor body is according to the present invention preferably carried out by a per se known blow molding process. This process is schematically illustrated in FIG. 1(A) and (B). A flexible tube from plastic material preferred a flexible tube from polypropylene 2, heated up to a temperature of approximately 180° C. is fed between the blow mold halves 1, 1. The heating of the flexible tube 2 from polypropylene serves for an the improved deformability in the blow mold.

Then, the blow mold halves 1, 1′ are moved against each other in direction of arrow until the edges 5 of the blow mold halves 1, 1′ support each other and sealingly close the blow mold (FIG. 1 (B)). Thereafter, the flexible tube 2 from polypropylene situated in the blow mold is expanded by means of a preferred compressed-air piping 3 according to the present invention and thereby formed in the shape defined by the blow mold. By the expanding process the plastic material is pressed against the inner surfaces 4 of the blow mold halves 1, 1′ and takes on the complementary shape to the inner surfaces 4 and their surface configuration as structure and roughness.

According to the present invention, blow mold halves 1, 1′ with different inner surface structures are used in order to manufacture blow molded sun visor bodies 10 with different surface configurations. Nap patterns, grooves, structured squares and other shapes are possible configurations of the inner surface 4 of the blow mold halves 1, 1′ which produce different optical and haptical effects with the user, respectively.

Besides the surface structure of the blow molded sun visor body 10 its colour can be varied according to the present invention. A colour variation is caused by the coloring of the polypropylene which is preferably used according to the present invention before it is extruded to a flexible tube 2 from polypropylene. Polypropylene is colored for example by using organic or inorganic pigments. In that way, the transparent or non-transparent colour configuration of the blow molded sun visor body 10 is adapted to the interior fittings of the motor vehicle so that no expensive procedure steps as for example the cut to size and ultrasonic sealing of a plastic cover as described above are necessary.

Therefore, a cost-efficient blow molded sun visor adapted in colour and surface configuration to the interior fittings of a motor vehicle can be produced by using the present method according to the first embodiment of the present invention.

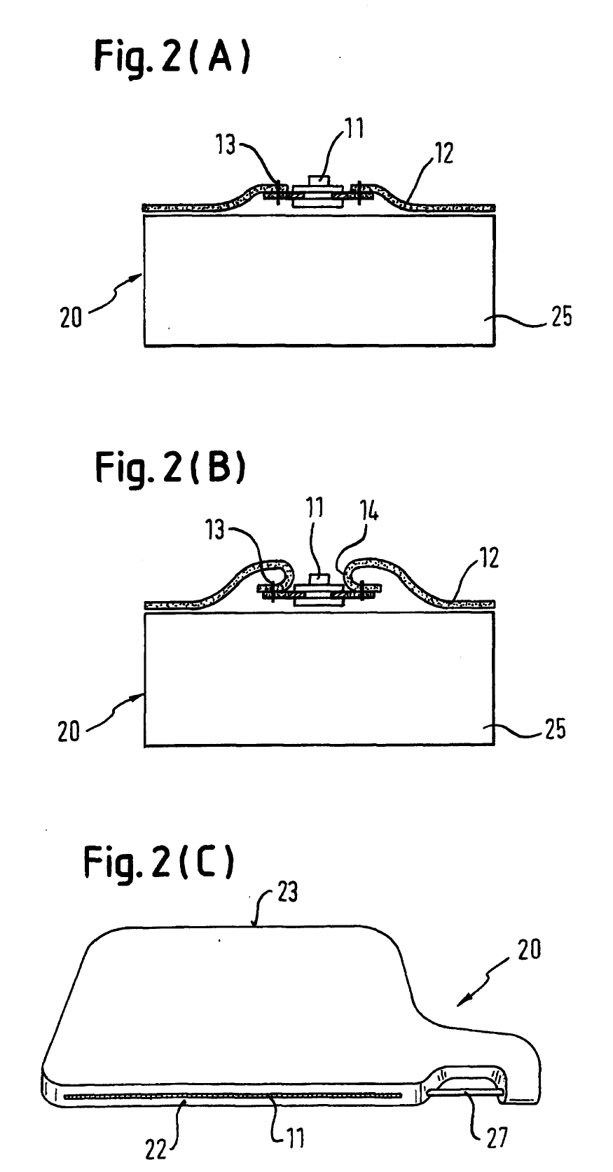

The second preferred embodiment of the present invention relates to a sun visor which comprises a cloth cover 12 with a zipper 111 for covering the sun visor body 25. The zipper 11 closing the cloth cover 12 of the sun visor body 15 extends preferably along one of the narrow front sides of the sun visor body 25 (FIG. 2 (C)) and anymore preferably along that narrow front side of the sun visor which extends in the direct vicinity of the bearing axis 27 of the sun visor. In this embodiment the cloth covered sun visor body 25 can be installed in the interior of the motor vehicle in that way that the front side 22 of the sun visor 20 with zipper 11 is situated at the side opposite to the passengers and it is therefore not visible. Two preferred embodiments are shown in FIG. 2 (A) and (B).

As shown in FIG. 2 (A) and (B), the zipper 11 is sewn on the cloth cover in different ways. Referring to FIG. 2 (A), the zipper 11 is attached for example to both opposed ends of the cloth cover 12, respectively by a seam 13. The seam 13 is visible from outside in that way of attaching. Nevertheless, this way of sewing on can be easily performed and does not require complicated technical means whereby the cloth cover according to the present invention and corresponding to the second embodiment can be produced with low costs.

FIG. 2 (B) shows a further way of attaching the zipper 11 to the cloth cover 12. Here, the zipper 11 is according to a third embodiment of the present invention attached to 180′-folded ends of the opposed ends of the cloth cover 12 by concealed seams 13. This embodiment provides a concealed or from outside invisible seam 13. Additionally, the zipper 11 is partly or completely covered by the resuiting hem 14 which improves the appearance of the sun visor 20 when the seam is to be situated in a visible region for the passengers for example at the front side 23 of the sun visor 20 turned toward the passengers of the motor vehicle, see FIG. 2 (C).

Furthermore according to a preferred embodiment, the zipper 11 is positioned at the front side 22 in the direct vicinity of the bearing axis 27 of the sun visor.

### LIST OF REFERENCE NUMBERS

1, 1′ blow mold halves
2 flexible tube from plastic material
3 compressed-air piping
4 inner surface of the blow mold halves 1, 1′
5 edge of the blow mold halve
6 sun visor body
11 zipper
12 end of the cloth cover
13 seam
14 hem
20 sun visor with cloth cover
22, 23 front sides of the sun visor
25 sun visor body
26 bearing axis

1. Method for manufacturing a blow molded sun visor (10) from plastic material, in particular polypropylene (2), with different outer surfaces of the sun visor, characterized in that:
a) the polypropylene (2) of the blow molded sun visor (10) is nontransparently ad colored; and
b) the surface structure and roughness of the outer surface of the sun visor (10) is complementary shaped to the surface structure of the inner surfaces (4) of the blow mold halves (1, 1′) during blow molding.

2. Method according to claim 1 wherein the polypropylene (2) is colored by pigments.

3. Method according to claim 1 wherein blow mold halves (1, 1′) with different surface structure and roughness of the inner surfaces are used.

4. Sun visor body (25) with cloth cover (12) characterized in that said cloth cover (12) comprises a zipper (11).

5. Sun visor body (25) according to claim 4 characterized in that said zipper (11) is attached to opposed ends of said cloth cover (12) or at 180°-folded, opposed ends of said cloth cover (12).

6. Sun visor body (25) according to claim 5 characterized in that said zipper (11) is partly or completely covered by the ends of the cloth cover (12).

7. Sun visor body (25) according to one of the claims 4 to 6 characterized in that the zipper (11) is positioned at one of the front sides (22, 23) of the sun visor body (25).

8. Sun visor body (25) according to claim 7 characterized in that the zipper (11) is positioned at the front side (22) in the direct vicinity of bearing axis (27) of the sun visor (20).
